(19) United States
(12) Patent Application Publication
(10) Pub. No.: US 2026/0176849 A1
(43) Pub. Date: Jun. 25, 2026

(54) DOUBLE-HANDLE FAUCET

(71) Applicant: Xiamen Lota International Co., Ltd., Xiamen (CN)

(72) Inventors: Liming YE, Xiamen (CN); Shuanglin BAI, Xiamen (CN); Youcheng ZHANG, Xiamen (CN); Chuanbao ZHU, Xiamen (CN)

(21) Appl. No.: 19/318,662

(22) Filed: Sep. 4, 2025

(30) Foreign Application Priority Data
Dec. 24, 2024 (CN) 202411914579.2

(51) Int. Cl. E03C 1/04; F16K 11/00; F16K 11/20

(52) U.S. Cl. CPC E03C 1/0402; F16K 11/207; F16K 19/006

(57) ABSTRACT

A double-handle faucet includes a panel body, a water outlet member, two valve assemblies, and a pipeline assembly. The panel body comprises includes a cover plate, a panel wall, and two valve seat bodies, and the cover plate is configured to cover the panel wall. The water outlet member includes a pipe body, an adapter, and a fixing member. The adapter is connected to the cover plate and the panel wall, and a lower end of the pipe body is connected to the adapter. The fixing member is connected to the adapter and located below the panel wall. The pipeline assembly includes two inlet-outlet pipe assemblies and a water outlet pipe, and the two inlet-outlet pipe assemblies are respectively in communication with the two valve assemblies. The two inlet-outlet pipe assemblies are respectively connected to the water outlet pipe, and the water outlet pipe is connected to a water outlet head.

### RELATED APPLICATIONS

This application claims priority to Chinese patent application number 202411914579.2, filed on Dec. 24, 2024. Chinese patent application number 202411914579.2 is incorporated herein by reference.

### FIELD OF THE DISCLOSURE

The present disclosure relates to the field of sanitary faucets, and in particular to a double-handle faucet.

### BACKGROUND OF THE DISCLOSURE

Currently, common double-handle faucets on the market are widely used in kitchens and bathrooms, and a typical structure of double-handle faucets mainly comprises a faucet body component, valve assemblies, etc. The faucet body component is typically designed in an H-shape and comprises valve seat bodies on two sides of the faucet body component for installing and securing the valve assemblies to control water flow. A middle part of the faucet body component comprises a water outlet, and the valve seat bodies on the two sides of the faucet body component are connected to the water outlet through internal flow channels. These internal flow channels are directly formed within a structure of the faucet body component to ensure that water can flow from the valve assemblies to the water outlet and be discharged smoothly. During installation, bottoms of the valve seat bodies are inserted into a countertop. An outer side of each of the valve seat bodies is designed with threads and is secured to the countertop with a nut, ensuring stability of the double-handle faucet and ease of installation.

However, this H-shaped faucet body component has significant limitations. Since the internal flow channels need to be directly formed in the faucet body component, a thickness of the faucet body component cannot be significantly reduced to ensure sufficient structural strength and machining precision of the internal flow channels. As a result, this type of faucet appears relatively bulky and fails to meet current consumer demand for simple and slim products. Additionally, a thicker faucet body component incurs higher material costs, and a heavy design may also increase the complexity and time required for installation.

### BRIEF SUMMARY OF THE DISCLOSURE

The purpose of the present disclosure is to overcome the shortcomings of the aforementioned existing technology and provide a double-handle faucet that enables a thin panel design.

To address the above technical problem, the present disclosure provides a double-handle faucet, comprising a panel body, a water outlet member, two valve assemblies, and a pipeline assembly.

The panel body comprises a cover plate, a panel wall, and two valve seat bodies, and the two valve seat bodies are connected to two sides of the panel wall. The two valve assemblies are respectively disposed in the two valve seat bodies, and the cover plate is configured to cover the panel wall.

The water outlet member comprises a pipe body, an adapter, and a fixing member. The adapter is connected to the cover plate and the panel wall, and a lower end of the pipe body is connected to the adapter.

The fixing member is connected to the adapter and located below the panel wall, so as to secure the panel wall on a countertop.

The pipeline assembly comprises two inlet-outlet pipe assemblies and a water outlet pipe, and the two inlet-outlet pipe assemblies are respectively connected to the two valve seat bodies to be in communication with the two valve assemblies. The two inlet-outlet pipe assemblies are respectively connected to the water outlet pipe, and the water outlet pipe is connected to a water outlet head at a distal end of the pipe body.

In a preferred embodiment, the adapter comprises a base, and the base comprises a plurality of buckles. The panel wall comprises a plurality of grooves, and the cover plate comprises one or more position-limiting surfaces corresponding to the plurality of grooves. When the cover plate fixedly covers the panel wall, the one or more position-limiting surfaces and the plurality of grooves form a plurality of buckle holes, and the base is configured to be buckled to the plurality of buckle holes.

In a preferred embodiment, the base comprises a top wall and a surrounding wall. The surrounding wall is disposed on a lower side of the top wall, and the panel wall comprises a mounting hole. The surrounding wall is configured to be adaptively disposed in the mounting hole. The top wall is configured to abut an upper side of the cover plate, and the plurality of buckles are disposed on a periphery of the top wall.

In a preferred embodiment, an inner wall surface of the surrounding wall is fixedly connected to the fixing member.

In a preferred embodiment, the fixing member comprises a threaded pipe and a nut seat. The threaded pipe is threadedly connected to the inner wall surface of the surrounding wall, and the nut seat is threadedly connected onto the threaded pipe, enabling the nut seat to abut a lower side of the countertop.

In a preferred embodiment, the adapter comprises a base and an adapter portion. The base is connected to the panel wall and the cover plate, and the pipe body is rotatably sleeved on the adapter portion.

In a preferred embodiment, each of the two inlet-outlet pipe assemblies comprises a connection seat, a water supply pipe, a water distribution pipe, and a connection buckling member. A first end of the water supply pipe and a first end of the water distribution pipe are respectively connected to the connection seat. A second end of the water supply pipe is configured to be connected to an external water source, and a second end of the water distribution pipe is connected to the water outlet pipe. The connection seat is detachably connected to a lower end of a corresponding one of the two valve seat bodies.

Two sides of the lower end of each of the two valve seat bodies comprises guiding rails extending along a horizontal direction. When the connection seat is correspondingly connected to the corresponding one of the two valve seat bodies, and the connection buckling member is configured to be disposed horizontally in the guiding rails and the connection seat to connect the corresponding one of the two valve seat bodies and the connection seat.

Each of the two inlet-outlet pipe assemblies further comprises a sealing sleeve, and the sealing sleeve is configured to be sleeved on and cover the connection buckling member to inhibit horizontal sliding of the connection buckling member.

In a preferred embodiment, the connection buckling member comprises a plate body and buckling members disposed on two sides of the plate body. The buckling members are connected to the guiding rails.

In a preferred embodiment, the double-handle faucet further comprises a converging joint, which is respectively connected to the two inlet-outlet pipe assemblies and the water outlet pipe.

Compared with the existing techniques, the technical solution has the following advantages.

1. The panel body comprises the cover plate, the panel wall, and the two valve seat bodies. The two valve seat bodies are connected to the two sides of the panel wall. The two valve assemblies are respectively disposed in the two valve seat bodies, and the cover plate is configured to cover the panel wall. The water outlet member comprises the pipe body, the adapter, and the fixing member. The adapter is connected to the cover plate and the panel wall, and the lower end of the pipe body is connected to the adapter. The fixing member is connected to the adapter and located below the panel wall, so that the panel wall can be fixed on the countertop. The pipeline assembly comprises the two inlet-outlet pipe assemblies and the water outlet pipe. The two inlet-outlet pipe assemblies are respectively connected to the two valve seat bodies to be in communication with the two valve assemblies. The two inlet-outlet pipe assemblies are respectively connected to the water outlet pipe, and the water outlet pipe is connected to the water outlet head at the distal end of the pipe body. The adapter is connected to the cover plate and the panel wall, and the lower end of the pipe body is connected to the adapter. The fixing member is connected to the adapter and located below the panel wall. The panel wall bears less force and can be made thinner, achieving a thin design.

### BRIEF DESCRIPTION OF THE DRAWINGS

FIG. 1 is a perspective view of a double-handle faucet in a preferred embodiment of the present disclosure.

FIG. 2 is an exploded view of the double-handle faucet in the preferred embodiment of the present disclosure.

FIG. 3 is a perspective view of an adapter, a panel body, and a pipeline assembly when connected in the preferred embodiment of the present disclosure.

FIG. 4 is an exploded view of the adapter, the panel body, and the pipeline assembly in the preferred embodiment of the present disclosure.

FIG. 5 is a perspective cross-sectional view of the adapter and the panel body connected in the preferred embodiment of the present disclosure.

FIG. 6 is a partially enlarged view of FIG. 5.

FIG. 7 is a cross-sectional view of the double-handle faucet in the preferred embodiment of the present disclosure.

### DETAILED DESCRIPTION OF THE EMBODIMENTS

The present disclosure will be further described below in conjunction with the accompanying drawings and embodiments.

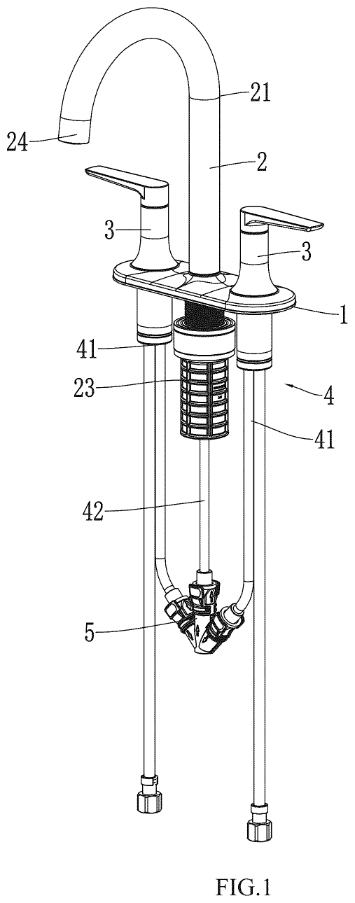

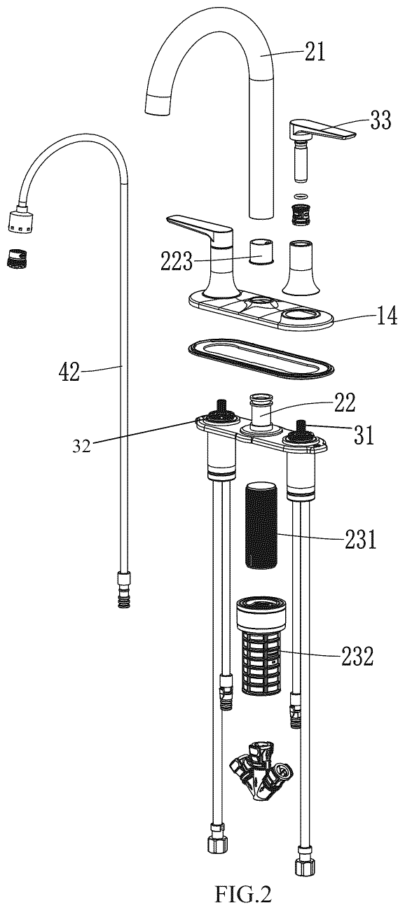

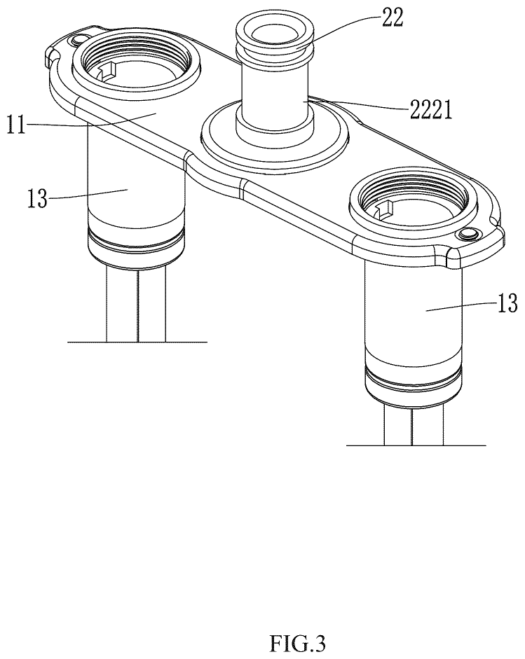

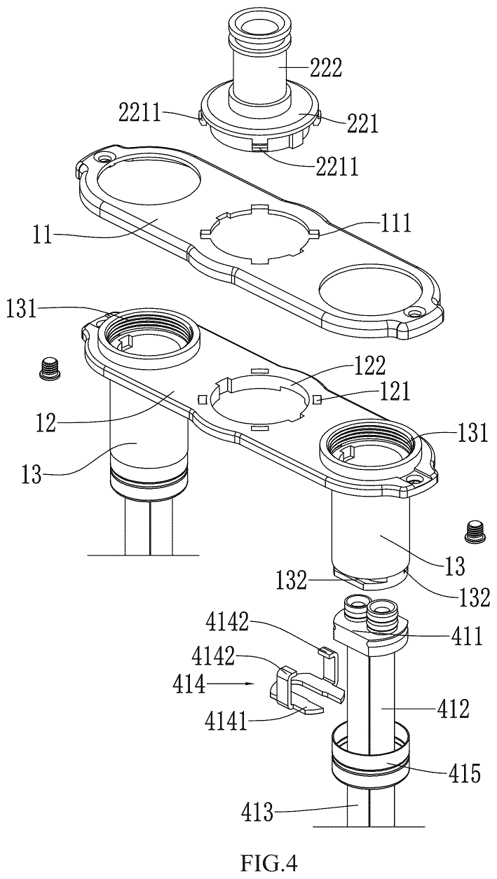

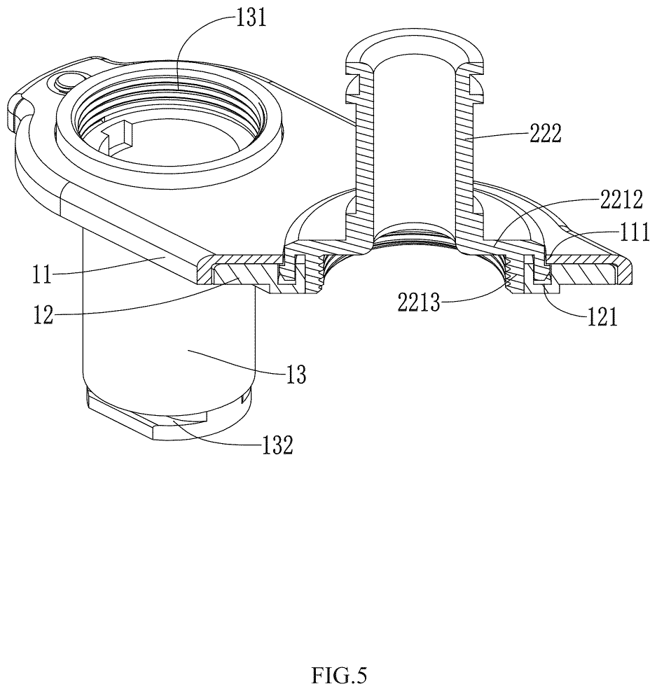

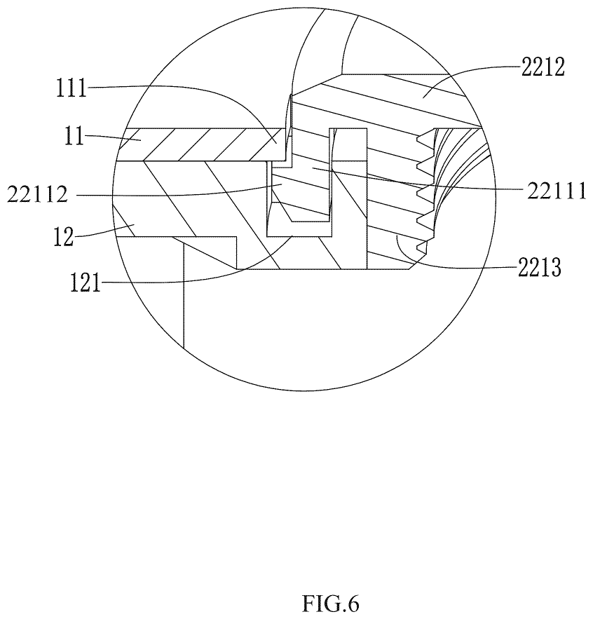

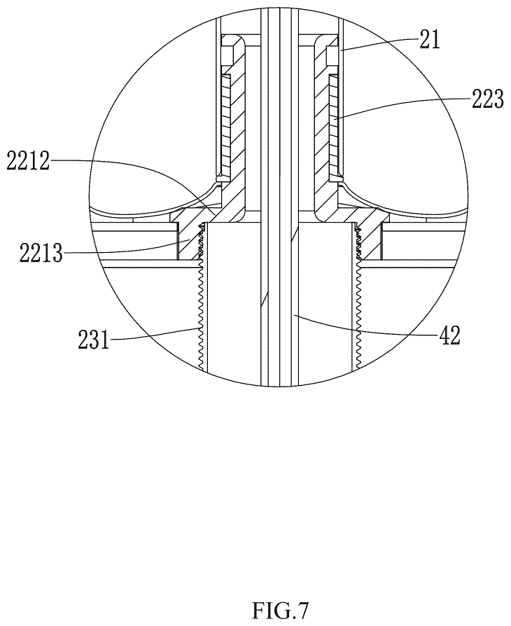

Referring to FIGS. 1-7, a double-handle faucet comprises a panel body 1, a water outlet member 2, a pipeline assembly 4, and two valve assemblies 3. The panel body 1 comprises a cover plate 11, a panel wall 12, and two valve seat bodies 13. The panel wall 12 has a thin-walled structure, and the two valve seat bodies 13 are respectively connected to two sides of the panel wall 12. The panel wall 12 and the two valve seat bodies 13 are integrally formed. The two valve seat bodies 13 extend downward along a height direction. Each of the two valve seat bodies 13 comprises an upper opening 131, and the two valve assemblies 3 are installed into the two valve seat bodies 13 through the upper openings 131. Each of the two valve assemblies 3 comprises a valve 31, a pressing lid 32, and a handle 33. The valve 31 is disposed in a corresponding one of the two valve seat bodies 13, and the pressing lid 32 is threadedly connected to the upper opening 131 to secure the valve 31. The handle 33 is connected to the valve 31 to control the valve 31.

The cover plate 11 is configured to cover the panel wall 12. In this embodiment, the cover plate 11 and the panel wall 12 are fixedly connected to each other by screws. A decorative plate 14 covers an outside of the cover plate 11.

The water outlet member 2 comprises a pipe body 21, an adapter 22, and a fixing member 23. The adapter 22 is connected to the cover plate 11 and the panel wall 12, and a lower end of the pipe body 21 is connected to the adapter 22. The fixing member 23 is connected to the adapter 22 and located below the panel wall 12, so as to secure the panel wall 12 on a countertop. The pipe body 21 is bent, the lower end of the pipe body 21 is rotatably sleeved on the adapter 22, and a water outlet head 24 is further disposed at a distal end of the pipe body 21. The adapter 22 is a revolved body, and the adapter 22 is respectively connected to the cover plate 11 and the panel wall 12. The fixing member 23 is connected to the adapter 22 and located below the panel wall 12, and the fixing member 23 is connected to the adapter 22, so that a force on the panel body 1 is relatively small.

The adapter 22 comprises a base 221, and the base 221 comprises a plurality of buckles 2211. The panel wall 12 comprises a plurality of grooves 121, and the cover plate 11 comprises one or more position-limiting surfaces 111 corresponding to the plurality of grooves 121. When the cover plate 11 fixedly covers the panel wall 12, the one or more position-limiting surfaces 111 and the plurality of grooves 121 form a plurality of buckle holes, and the base 221 can be buckled to the plurality of buckle holes. In this embodiment, the plurality of grooves 121 can be formed on the panel wall 12, and edges of the plurality of grooves 121 do not need to be formed with the one or more position-limiting surfaces 111. By covering the cover plate 11 on the panel wall 12, the one or more position-limiting surfaces 111 are aligned with the plurality of grooves 121 to form the plurality of buckle holes. Each of the plurality of buckles 2211 comprises an elastic arm 22111 and a buckle block 22112 connected to a distal end of the elastic arm 22111. After the plurality of buckles 2211 are buckled to the plurality of buckle holes, when attempting to pull out the plurality of buckles 2211, the buckle block 22112 will abut the one or more position-limiting surfaces 111, and the panel wall 12 is not subjected to force at this time.

The base 221 comprises a top wall 2212 and a surrounding wall 2213, and the surrounding wall 2213 is disposed on a lower side of the top wall 2212. The panel wall 12 comprises a mounting hole 122, and the surrounding wall 2213 can be adaptively inserted into the mounting hole 122. The top wall 2212 can abut an upper side surface of the cover plate 11, and the plurality of buckles 2211 are disposed on a periphery of the top wall 2212. The top wall 2212 can abut the upper side surface of the cover plate 11, and the top wall 2212 does not directly abut the panel wall 12. An inner wall surface of the surrounding wall 2213 is fixedly connected to the fixing member 23. The fixing member 23 comprises a threaded pipe 231 and a nut seat 232. The threaded pipe 231 is threadedly connected to the inner wall surface of the surrounding wall 2213, and the nut seat 232 is threadedly connected onto the threaded pipe 231, enabling the nut seat 232 to abut a lower side of the countertop.

The adapter 22 further comprises an adapter portion 222. The base 221 is connected to the panel wall 12 and the cover plate 11, and the pipe body 21 is rotatably sleeved on the adapter portion 222. A peripheral wall of the adapter portion 222 forms a circumferential rotation groove 2221. A rotation bushing 223 is disposed on the circumferential rotation groove 2221, and the rotation bushing 223 is disposed in the lower end of the pipe body 21.

The pipeline assembly 4 comprises two inlet-outlet pipe assemblies 41 and a water outlet pipe 42. The two inlet-outlet pipe assemblies 41 are respectively connected to the two valve seat bodies 13 to be in communicated with the two valve assemblies 3. The two inlet-outlet pipe assemblies 41 are both connected to the water outlet pipe 42, and the water outlet pipe 42 is connected to the water outlet head 24 at the distal end of the pipe body 21. Each of the two inlet-outlet pipe assemblies 41 comprises a connection seat 411, a water supply pipe 412, a water distribution pipe 413, and a connection buckling member 414. A first end of the water supply pipe 412 and a first end of the water distribution pipe 413 are respectively connected to the connection seat 411. A second end of the water supply pipe 412 is configured to be connected to an external water source, and a second end of the water distribution pipe 413 is connected to the water outlet pipe 42. The connection seat 411 is detachably connected to a lower end of a corresponding one of the two valve seat bodies 13. Two sides of the lower end of each of the two valve seat bodies 13 comprise guiding rails 132 extending in a horizontal direction. When the connection seat 411 is correspondingly connected to the corresponding one of the two valve seat bodies 13, the connection buckling member 414 can be horizontally inserted into the guiding rails 132 and the connection seat 411 to connect the corresponding one of the two valve seat bodies 13 and the connection seat 411. Each of the two inlet-outlet pipe assemblies 41 further comprises a sealing sleeve 415, and the sealing sleeve 415 is configured to be sleeved on and cover an outside of the connection buckling member 414 to inhibit horizontal sliding of the connection buckling member 414.

The first end of the water supply pipe 412 and the first end of the water distribution pipe 413 protrude from an end surface of the connection seat 411. When the connection seat 411 is aligned with an end surface of the lower end of the corresponding one of the two valve seat bodies 13, the first end of the water supply pipe 412 and the first end of the water distribution pipe 413 are inserted into the lower end of the corresponding one of the two valve seat bodies 13. The connection buckling member 414 slides horizontally into the guiding rails 132 from a side of the connection seat 411, corresponding to the guiding rails 132. Finally, the sealing sleeve 415 is sleeved to cover the connection buckling member 414 along an axial direction of the connection seat 411.

The connection buckling member 414 comprises a plate body 4141 and buckling members 4142 disposed on two sides of the plate body 4141. The buckling members 4142 are connected to the guiding rails 132. The double-handle faucet further comprises a converging joint 5, which is respectively connected to the two inlet-outlet pipe assemblies 41 and the water outlet pipe 42.

The aforementioned embodiments are merely some embodiments of the present disclosure, and the scope of the disclosure is not limited thereto. Thus, it is intended that the present disclosure cover non-substantive modifications of the present disclosure provided they are made based on the concept within the technical scope disclosed in the present disclosure by any technical person skilled in the art.

What is claimed is:

1. A double-handle faucet, comprising:
a panel body,
a water outlet member,
two valve assemblies, and
a pipeline assembly, wherein:
the panel body comprises a cover plate, a panel wall, and two valve seat bodies,
the two valve seat bodies are connected to two sides of the panel wall,
the two valve assemblies are respectively disposed in the two valve seat bodies,
the cover plate is configured to cover the panel wall,
the water outlet member comprises a pipe body, an adapter, and a fixing member,
the adapter is connected to the cover plate and the panel wall,
a lower end of the pipe body is connected to the adapter,
the fixing member is connected to the adapter and located below the panel wall, so as to secure the panel wall on a countertop,
the pipeline assembly comprises two inlet-outlet pipe assemblies and a water outlet pipe,
the two inlet-outlet pipe assemblies are respectively connected to the two valve seat bodies to be in communication with the two valve assemblies,
the two inlet-outlet pipe assemblies are respectively connected to the water outlet pipe, and
the water outlet pipe is connected to a water outlet head at a distal end of the pipe body.

2. The double-handle faucet according to claim 1, wherein:
the adapter comprises a base,
the base comprises a plurality of buckles,
the panel wall comprises a plurality of grooves,
the cover plate comprises one or more position-limiting surfaces corresponding to the plurality of grooves, and
when the cover plate fixedly covers the panel wall:
the one or more position-limiting surfaces and the plurality of grooves form a plurality of buckle holes, and
the base is configured to be buckled to the plurality of buckle holes.

3. The double-handle faucet according to claim 2, wherein:
the base comprises a top wall and a surrounding wall,
the surrounding wall is disposed on a lower side of the top wall,
the panel wall comprises a mounting hole,
the surrounding wall is configured to be adaptively disposed in the mounting hole,
the top wall is configured to abut an upper side of the cover plate, and
the plurality of buckles are disposed on a periphery of the top wall.

4. The double-handle faucet according to claim 3, wherein:
an inner wall surface of the surrounding wall is fixedly connected to the fixing member.

5. The double-handle faucet according to claim 4, wherein:
the fixing member comprises a threaded pipe and a nut seat,
the threaded pipe is threadedly connected to the inner wall surface of the surrounding wall, and
the nut seat is threadedly connected onto the threaded pipe so that the nut seat is configured to abut a lower side of the countertop.

6. The double-handle faucet according to claim 1, wherein:
the adapter comprises a base and an adapter portion,
the base is connected to the panel wall and the cover plate, and
the pipe body is rotatably sleeved on the adapter portion.

7. The double-handle faucet according to claim 1, wherein:
each of the two inlet-outlet pipe assemblies comprises a connection seat, a water supply pipe, a water distribution pipe, and a connection buckling member,
a first end of the water supply pipe and a first end of the water distribution pipe are respectively connected to the connection seat,
a second end of the water supply pipe is configured to be connected to an external water source,
a second end of the water distribution pipe is connected to the water outlet pipe,
the connection seat is detachably connected to a lower end of a corresponding one of the two valve seat bodies,
two sides of the lower end of each of the two valve seat bodies comprises guiding rails extending along a horizontal direction,
when the connection seat is correspondingly connected to the corresponding one of the two valve seat bodies, the connection buckling member is configured to be disposed horizontally in the guiding rails and the connection seat to connect the corresponding one of the two valve seat bodies and the connection seat,
each of the two inlet-outlet pipe assemblies further comprises a sealing sleeve, and
the sealing sleeve is configured to be sleeved on and cover the connection buckling member to inhibit horizontal sliding of the connection buckling member.

8. The double-handle faucet according to claim 7, wherein:
the connection buckling member comprises a plate body and buckling members disposed on two sides of the plate body, and
the buckling members are connected to the guiding rails.

9. The double-handle faucet according to claim 1, comprising:
a converging joint, wherein:
the converging joint is respectively connected to the two inlet-outlet pipe assemblies and the water outlet pipe.
